(19) United States
(12) Patent Application Publication
(10) Pub. No.: US 2017/0344350 A1
(43) Pub. Date: Nov. 30, 2017

(54) TRIAGE SELF-REPAIR FOR STATICALLY COMPILED EXECUTABLES

(71) Applicant: Oracle International Corporation, Redwood City, CA (US)

(72) Inventors: SPIROS KALOGEROPULOS, Los Gatos, CA (US); PARTHA TIRUMALAI, Fremont, CA (US)

(21) Appl. No.: 15/167,787

(22) Filed: May 27, 2016

(51) Int. Cl. G06F 9/45

(52) U.S. Cl. CPC G06F 8/443

(57) ABSTRACT

Embodiments provide systems and methods for generating application binaries having self-triage repair capabilities. For example, embodiments enable an independent software vendor (ISV) to statically compile application source code into a self-triaging application binary (STAB) having a release-time executable. Should the release-time executable generate runtime errors when executed, the STAB can apply one or more triage approaches to itself to morph into a triaged executable that executes without some or all of the compiler optimizations that resulted in the errors (e.g., and without generating those errors on subsequent execution). Various implementations of the triage approaches can include one or more levels of de-optimization of functions in the STAB, such as by de-optimizing the last function executed prior to the runtime failure, de-optimizing some or all of a stack trace leading up to the last function executed prior to the runtime failure, de-optimizing all functions executed prior to the runtime failure, etc.

### FIELD

Embodiments of the present invention relate generally to compilers, and, more particularly, to triage self-repair approaches for statically compiled executables.

### BACKGROUND

The development of software applications typically involves writing software code in a high-level programming language and translating the code into a lower-level machine language that can be executed by a computer system. Many so-called “compiler” applications exist to effectuate the translation from the high-level “source code” into a lower-level “executable code.” These compilers may implement many different types of functionality, for example, that enhance the efficiency of the compilation process through various compiler optimizations.

Advanced compilers can implement hundreds of optimizations that have been developed over the past few decades. While the optimizations can help functions of the executables run more efficiently in end users' computational environments, the optimizations can, in some cases, modify functions in unintended or incorrect ways and result in “bugs” in the executable. For example, certain functions optimized in certain ways can generate runtime errors when executed, such as failing data tests on certain user input data, crashing (e.g., causing core dumps), etc. In such cases, the end-user may be unable to execute the application until a new compiled version of the application is received from the software vendor (e.g., after recompiling the application with a new compiler that includes fixes for those bugs).

### BRIEF SUMMARY

Among other things, systems and methods are described for statically compiling applications to have self-triage repair capabilities. For example, embodiments enable an independent software vendor (ISV) to statically compile application source code into a self-triaging application binary (STAB) having a release-time executable. Should the release-time executable generate runtime errors when executed, the STAB can apply one or more triage approaches to itself to morph into a triaged executable that executes without some or all of the compiler optimizations that resulted in the errors (e.g., and without generating those errors on subsequent execution). Various implementations of the triage approaches can include one or more levels of de-optimization of functions in the STAB, such as by de-optimizing the last function executed prior to the runtime failure, de-optimizing some or all of a stack trace leading up to the last function executed prior to the runtime failure, de-optimizing all functions executed prior to the runtime failure, etc. In some implementations, actions taken by the triage approaches can be reported back to the ISV (and/or directly or indirectly to the compiler vendor) so that the bugs can be fixed in subsequent releases of the STAB.

According to one set of embodiments, a computer-implemented compiler system is provided. The compiler system includes a source code store to receive and store source code for an application, a function parser, a code optimizer, and a compiler driver. The function parser has: a source code input coupled with the source code store; and an unoptimized function-set output comprising multiple unoptimized functions parsed from the source code. The code optimizer has: an unoptimized function-set input coupled with the unoptimized function-set output; an optimized function-set output including multiple optimized functions, each statically compiled from one of the unoptimized functions according to an associated compiler optimization; and a de-optimized function-set output including multiple de-optimized functions, each corresponding to one of the optimized functions, and each statically compiled without the optimization associated with the corresponding optimized function. The compiler driver is coupled with the code optimizer and generates an application binary to include: the optimized functions; the de-optimized functions; a linking loader that operates to direct execution of the application in accordance with the optimized functions; and a triage module that operates to detect a self-triage trigger in association with detecting a runtime error resulting from execution of a suspect one of the optimized functions, identify one of the de-optimized functions as corresponding to the suspect optimized function, and reconfigure the linking loader in response to the self-triage trigger to direct execution of the application in accordance with the identified de-optimized function in place of the suspect optimized function.

According to another set of embodiments, a self-triaging application binary (STAB) is provided. The STAB includes: multiple optimized functions, each generated by a static compiler according to an associated compiler optimization; multiple de-optimized functions, each de-optimized function corresponding to one of the optimized functions and generated by the static compiler without the compiler optimization associated with the corresponding optimized function; a linking loader configured by the static compiler to direct execution of an application in accordance with the optimized functions; and a triage module generated by the static compiler to detect a self-triage trigger in association with detecting a runtime error resulting from execution of a suspect one of the optimized functions, identify one of the de-optimized functions as corresponding to the suspect optimized function, and reconfigure the linking loader in response to the self-triage trigger to direct execution of the application in accordance with the identified de-optimized function in place of the suspect optimized function.

According to another set of embodiments, a method is provided for self-triaging an application binary. The method includes: directing execution of an application by a computer-implemented linking loader in accordance with multiple optimized functions of the application binary, each optimized function generated by a static compiler according to an associated compiler optimization; detecting a self-triage trigger in association with detecting a runtime error resulting from execution of a suspect one of the optimized functions; identifying one of multiple de-optimized functions of the application binary as corresponding to the suspect optimized function, each of the plurality of de-optimized functions corresponding to one of the optimized functions and generated by the static compiler to be less optimized than the corresponding optimized function; and reconfiguring the linking loader in response to detecting the self-triage trigger to direct execution of the application in accordance with the identified de-optimized function in place of the suspect optimized function.

### BRIEF DESCRIPTION OF THE DRAWINGS

The present disclosure is described in conjunction with the appended figures:

FIG. 1 shows a software development environment to provide a context for various embodiments;

FIG. 2 shows a block diagram of an embodiment of an execution environment in which embodiments of a self-triaging application binary (STAB) can be run, according to various embodiments;

FIG. 3 shows an exemplary computational environment, in the context of which various embodiments may be implemented; and

FIG. 4 shows a flow diagram an illustrative method for self-triaging an application binary, according to various embodiments.

In the appended figures, similar components and/or features may have the same reference label. Further, various components of the same type may be distinguished by following the reference label by a second label that distinguishes among the similar components. If only the first reference label is used in the specification, the description is applicable to any one of the similar components having the same first reference label irrespective of the second reference label.

### DETAILED DESCRIPTION

In the following description, numerous specific details are set forth to provide a thorough understanding of the present invention. However, one having ordinary skill in the art should recognize that the invention may be practiced without these specific details. In some instances, circuits, structures, and techniques have not been shown in detail to avoid obscuring the present invention.

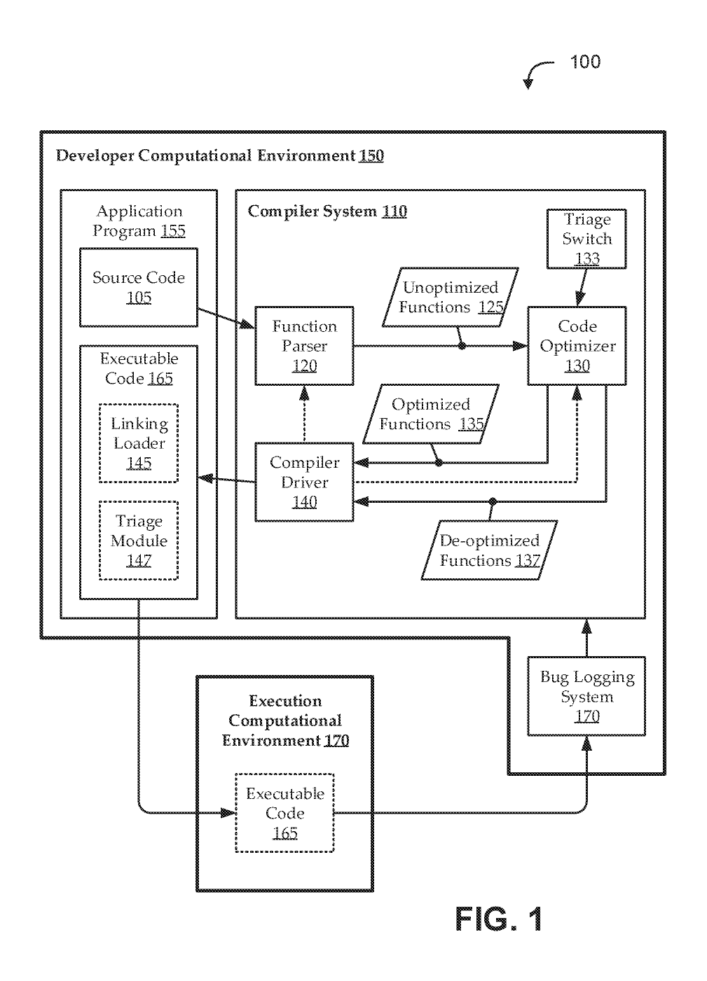

Turning first to FIG. 1, a software application environment 100 is shown to provide a context for various embodiments. For the sake of clarity, the application environment 100 is broken generally into a developer computational environment 150 and an execution computational environment 170. These computational environments can be part of a single computational environment (e.g., implemented on a single computer) or distributed among multiple computational environments. For example, the developer computational environment 150 can be optimized for compiling large applications and can exploit features, such as multi-core and/or parallel processing, resource off-loading (e.g., using cloud-based resources), etc.; and the execution computational environment 170 can be an end-user computer, a development computer configured to manifest expected features of an end-user computer, etc.

As illustrated, the developer computational environment 150 can include a compiler system 110 and an application program 155 (i.e., the target application to be compiled). The compiler system 110 can generally translate un-compiled “source” code 105 into compiled “executable” code 165 by using a number of compiler components, each configured to apply certain compiler system 110 functionality to certain types of code. Each compiler component can be implemented as a sub-component of another compiler component, can include one or more sub-components, etc. The compiler system 110 can run on a developer computational environment 150 (e.g., a personal computer or other computing platform). A developer (e.g., a software programmer) may develop the source code 105 by writing and debugging code segments in a high-level programming or scripting language, like “Java,” “C,” “PHP,” “Visual Basic,” “Perl” etc. The developer can then send the source code 105 to the compiler system 110 (e.g., which may or may not be stored locally on the developer computational environment 150), and the compiler system 110 can compile the source code 105 to compiled executable code 165 using its various compiler components. As illustrated, the compiler components can include a function parser 120, a code optimizer 130, and a compiler driver 140. Though the various components are shown separately, they can be implemented in any suitable manner as one or more components. For example, as indicated by dashed arrows, the function parser 120 and/or the code optimizer 130 can be directed by the compiler driver 140, As described herein, embodiments of the compiler system 110 can statically compile the source code 105 into executable code 165 that has a self-triaging application binary (STAB).

Embodiments of the function parser 120 can include a source code input coupled with an output of a source code store having the source code 105 stored thereon. The function parser 120 can also include an unoptimized function-set output having multiple unoptimized functions 125 parsed from the source code 105. In some implementations, the unoptimized functions 125 can include all functions identified in the source code 105. In other implementations, the unoptimized functions 125 include only a subset of the functions of the source code 105, such as only those functions that can potentially he optimized by the code optimizer 130.

Embodiments of the code optimizer 130 can include an unoptimized function-set input, an optimized function-set output, and a de-optimized function-set output. The unoptimized function-set input is coupled with the unoptimized function-set output of the function parser 120 to receive the unoptimized functions 125. In some implementations, the function parser 120 has capabilities beyond parsing. For example, while “parsers” typically do not output code (e.g., as may be seen at the unoptimized function-set output), implementations of the function parser 120 can perform any functionality useful in outputting the unoptimized function-set output, as described herein. The optimized function-set output includes multiple optimized functions 135 (e.g., which can include multiple versions of optimized functions 135), each statically compiled from one of the unoptimized functions 125 according to an associated compiler optimization. For example, embodiments of the code optimizer 130 can implement hundreds of compiler optimizations (including many developed over the past few decades) and/or can apply a subset of available optimizations (e.g., as indicated by command line options) to some or all the source code 105. Such available compiler optimizations can be generally classified into speculative optimizations and non-speculative optimizations. Speculative optimizations (e.g., prefetch generation for direct or indirect memory accesses) can contribute to performance improvement, so long as benefits obtained from the optimized code outweigh any run time costs of the speculation. Non-speculative optimizations are generally beneficial, but can be “tuned” with parameters for maximum benefit. For example, loop unrolling can often be classified as non-speculative, but the extent of the unrolling can be a parameter that can change the impact of the optimization. Similarly, some compiler optimizations include parallelizing of code segment execution, or the like, which can be selectively applied and/or tuned to change the impact of the optimization.

The de-optimized function-set output of the code optimizer 130 can include multiple de-optimized functions 137 (e.g., which can include multiple versions of de-optimized functions 137), each corresponding to one of the optimized functions 135, and each statically compiled without the compiler optimization associated with the corresponding optimized function 135. In some implementations, some or all of the de-optimized functions 137 are not optimized at all (e.g., they are statically compiled without any compiler optimization applied). In other implementations, some or all of the de-optimized functions 137 are less optimized that their corresponding optimized functions 135. For example, many optimizations can be implemented more or less aggressively, thereby generating a more or less stable optimized function 135 (e.g., more or less compatible with different execution computational environments 170, with different user data, etc.). In still other implementations, multiple de-optimized functions 137 can correspond to a single optimized function 135. For example, the optimized function 135 can be optimized to a highest degree (e.g., most aggressive application of one or more compiler optimizations to the function), and two or more corresponding de-optimized functions 137 can be optimized to progressively lower degrees (e.g., the lowest degree of optimization may or may not be completely unoptimized). In some embodiments, the code optimizer 130 further includes a. triage switch input 133 that determines whether to generate a normal application binary (i.e., without self-triaging functionality) or to generate a STAB. In one implementation, the triage switch input 133 is controllable by a command line option. For example, an independent software vendor (ISV) can run a static compilation of the source code 105 using the compiler system 110 using terminal commands, and the terminal commands can include switches and/or other command line options.

Embodiments of the compiler driver 140 can be coupled with the code optimizer 130 (e.g., and the function parser 120) to generate the executable code 165 having an application binary (a STAB). The STAB can include the optimized functions 135, the de-optimized functions 137, a linking loader 145, and a triage module 147. The linking loader 145, when the executable code 165 is first released (referred to herein as the “release-time” executable code 165) can operate to direct execution of the application program 155 on an execution computational environment 170 in accordance with the optimized functions 135. For example, the release-time executable code 165 can run in the execution computational environment 170 in a way that looks as if the executable code 165 were generated by a conventional advanced compiler (e.g., with comparable optimization functionality). As described below, however, the executable code 165 is generated in such a way that the linking loader 145 can be reconfigured in the execution computational environment 170 for self-triaging in response to runtime errors. While sonic embodiments describe the linking loader 145 as part of the STAB, the linking loader 145 may or may not be packaged as part of the executable code 165. For example, the linking loader 145 can be separate from the executable code 165, and can be driven to select and replace functions in the executable code 165, as described herein.

The compiled executable code 165 can be delivered in any suitable manner to the execution computational environment 170. For example, the executable code 165 can be sent to an end-user using physical media, via a communications network, etc. In some cases, execution of the executable code 165 in the execution computational environment 170 can result in one or more runtime errors. The errors can manifest as a core dump, as incorrect output (e.g., a test data failure), etc. As described herein, the STAB is generated in such a way that, in response to detecting such a runtime error, the application binary can self-triage in an attempt to morph into an executable application binary that runs free of error. For example, the linking loader 145 and the triage module 147 can identify optimized functions 135 that are suspected of causing runtime errors and can effectively de-optimize some or all of those functions. In sonic embodiments, errors and/or information relating to self-triaging (e.g., the optimized functions 135 identified as suspect, de-optimized functions 137 used as replacements, successful attempts, unsuccessful attempts, etc.) can be sent back to a bug logging system 170 accessible to the ISV. For example, as illustrated, the bug logging system 170 can be implemented in the developer computational environment 150. In some cases, the ISV can use the information sent to the bug logging system 170 to fix those bugs in subsequent releases of the executable code 165 (e.g., by using a newer version of a compiler that includes bug fixes). For example, the self-triaging can be seen as a temporary fix to allow users to continue running the executable code 165 even while bugs are being fixed by the ISV.

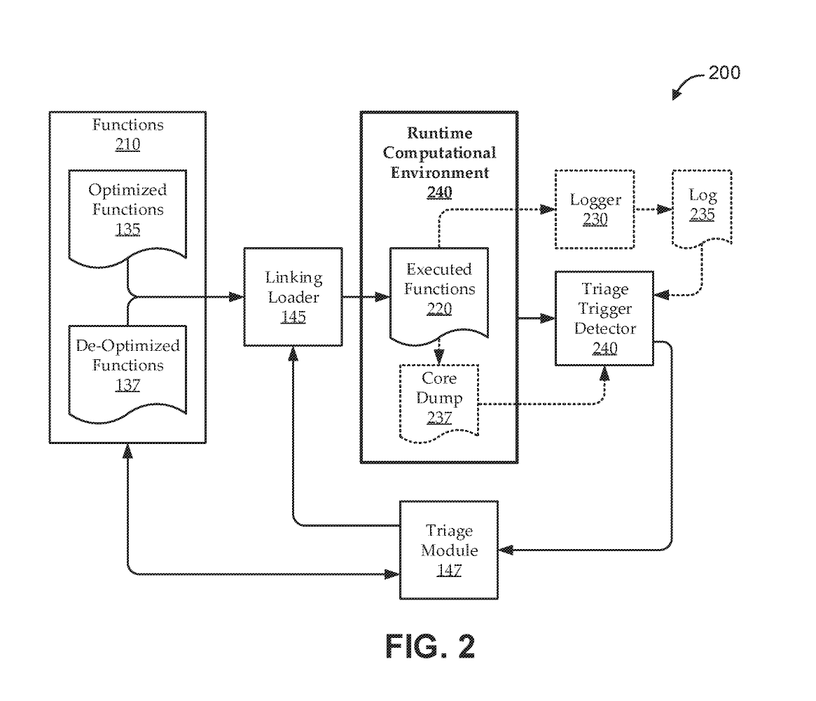

FIG. 2 shows a block diagram of an embodiment of an execution environment 200 (e.g., the execution computational environment 170 of FIG. 1) in which embodiments of a self-triaging application binary (STAB) can be run, according to various embodiments. As described with reference to FIG. 1, the STAB can include compiled functions 210 (e.g., including optimized functions 135 and corresponding de-optimized functions 137), a linking loader 145, and a triage module 147. As illustrated, the linking loader 145 can load the application for execution in a runtime computational environment 240 by pointing to the optimized functions 135 and/or de-optimized functions 137. In some embodiments, a release-time configuration of the linking loader 145 loads the application for execution in accordance with the optimized functions 135 (e.g., wherever an optimized function 135 is available in the compiled functions 210), and replaces those functions with their de-optimized function 137 counterparts only upon self-triaging reconfiguration of the linking loader 145.

Execution of the loaded compiled functions 210 in the runtime computational environment 240 results in a set of one or more executed functions 220. In some embodiments, as functions are executed, an indication of which functions have been executed (e.g., since the application started running, since a particular branch point in the executable code 165, and/or since any other relevant execution point) is maintained by a logger module 230 in a log 235. For example, the log 235 can include function names and/or other relevant information about the executed functions. Alternatively or additionally, components of the runtime computational environment 240 can maintain an indication of executed functions 220 in certain instances, For example, when certain runtime errors occur, the runtime computational environment 240 can automatically generate a core dump 237 that can indicate a stack trace of executed functions 220 leading up to the error. In some implementations, the STAB is compiled (e.g., as in FIG. 1) and/or executed (e.g., as in FIG. a manner that permits control of whether to maintain a function log 235, For example, the application can be run in the runtime computational environment 240 with a command line option that keeps a function log 235, or the source code 105 can be compiled by the compiler system 110 to automatically maintain a function log 235.

As described above, in some cases, execution of the application using the optimized functions 135 can result in one or more runtime errors. Embodiments of the triage module 147 of the executable code 165 can include a triage trigger detector 240 that operates to detect a self-triage trigger in association with detecting such a runtime error. For example, during the execution of the application binary, a core dump 237 or incorrect data output can result from one or more bugs in the optimized application binary as loaded by the linking loader 145. It can be assumed that the hug resulted from an issue with executing a suspect one of the optimized functions 135, such as the last-executed function prior to the runtime error and/or one or more other functions executed prior to occurrence of the runtime error. In some embodiments, the self-triage trigger is automatically generated in response to detecting the runtime error. In other embodiments, after a runtime error occurs, a user can manually run a diagnostic function, or the like; and the self-triage trigger can be generated in response thereto. Detection of the self-triage trigger by the triage trigger detector 240 can include determining the one or more optimized functions 135 suspected of causing the runtime error(s).

The triage module 147 can further identify one of the de-optimized functions 137 as corresponding to the suspect optimized function(s) 135. As described above, one or more de-optimized functions 137 is compiled as part of the STAB to correspond to each compiled optimized function 135. The identification of corresponding functions by the triage module 147 can be performed in response to detecting the self-triage trigger, prior to occurrence of the runtime error, or at any other suitable time. Such detection can be performed in any suitable manner, such as by consulting a lookup table, by naming convention of the functions, etc.

Having identified a de-optimized function 137 as corresponding to the suspect optimized function 135, the triage module 147 can reconfigure the linking loader 145 (in response to the self-triage trigger) to direct execution of the application in accordance with the identified de-optimized function 137 in place of the suspect optimized function 135. Some embodiments of the triage module 147 can identify multiple suspect optimized functions 135 for replacement with corresponding de-optimized functions 137. As one example, the core dump 237 and/or a function log 235 can be consulted to determine a stack trace of the functions (e.g., optimized functions 135) that led up to execution of the suspect optimized function 135, such that some or all functions in the stack trace are treated as suspect. As another example, the core dump 237 and/or function log 235 can be consulted to determine all the functions (e.g., optimized functions 135) executed as part of the application execution prior to the runtime error, such that some or all of those previously executed functions 220 are treated as suspect.

Some embodiments can iteratively attempt to fix the runtime error (e.g., automatically, or in response to one or more user-initiated commands). For example, implementations can first attempt re-execution of the application binary with only the last-executed optimized function 135 replaced by a corresponding de-optimized function 137. If the first attempt is unsuccessful, implementations can second attempt re-execution of the application binary with all optimized functions 135 in a stack trace replaced by corresponding de-optimized functions 137. If the first and second attempts are unsuccessful, implementations can third attempt re-execution of the application binary with all previously executed optimized functions 135 replaced by corresponding de-optimized functions 137. Similarly, in one or more such iterations, sub-iterations can try different levels of de-optimized functions 137 (where multiple de-optimized functions 137 correspond to a single suspect optimized function 135).

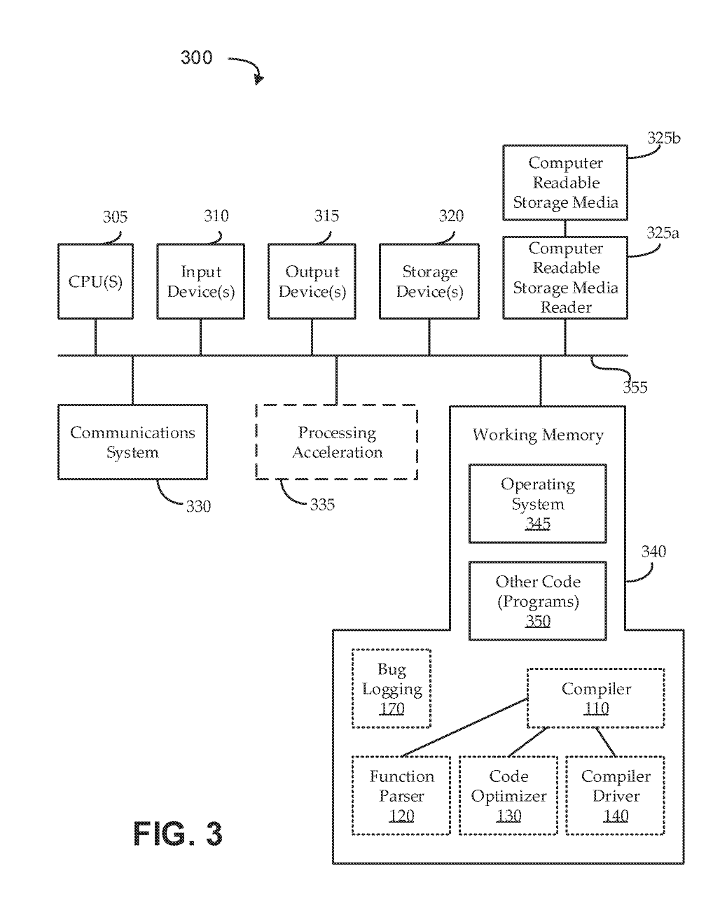

Various functionality described above can be implemented in one or more computational environments, such as developer computational environment 150 and/or execution computational environment 170 of FIG. 1, and/or runtime computational environment 240 of FIG. 2. FIG. 3 shows an exemplary computational environment 300, in the context of which various embodiments may be implemented. The computational environment 300 may be implemented as or embodied in single or distributed computer systems, or in any other useful way. The computational environment 300 is shown including hardware elements that may be electrically coupled via a bus 355.

The hardware elements may include one or more central processing units (CPUs) 305, one or more input devices 310 (e.g., a mouse, a keyboard, etc.), and one or more output devices 315 (e.g., a display device, a printer, etc.). The computational environment 300 may also include one or more storage devices 320. By way of example, storage device(s) 320 may be disk drives, optical storage devices, solid-state storage device such as a random access memory (RAM) and/or a read-only memory (ROM), which can be programmable, flash-updateable and/or the like. In some embodiments, the storage devices 320 can be used to store source code 105, executable code 165, and/or other suitable data.

The computational environment 300 may additionally include a computer-readable storage media reader 325a, a communications system 330 (e.g., a modem, a network card (wireless or wired), an infrared communication device, etc.), and working memory 340, which may include RAM and ROM devices as described above. In some embodiments, the computational environment 300 may also include a processing acceleration unit 335, which can include a DSP, a special-purpose processor, and/or the like.

The computer-readable storage media reader 325a can further be connected to a computer-readable storage medium 325btogether (and, optionally, in combination with storage device(s) 320) comprehensively representing remote, local, fixed, and/or removable storage devices plus storage media for temporarily and/or more permanently containing computer-readable information. The communications system 330 may permit data to be exchanged with a network and/or any other computer described above with respect to the computational environment 300.

The computational environment 300 may also include software elements, shown as being currently located within a working memory 340, including an operating system 345 and/or other code 350, such as an application program (which may be a client application, web browser, mid-tier application, RDBMS, etc.). For example, embodiments can be implemented as instructions, which, When executed by one or more processors 305, cause the processors 305 to perform certain functions. Such functions can include functionality of a compiler system 110, including any of a function parser 120, a code optimizer 130, a compiler driver 140, a bug logging module 170, etc., such as those described above with reference to FIGS. 1 and 2. For example, embodiments of the compiler 110 may interact with an application program as code 350 loaded into working memory 340. The compiler 110 can be a set of programs for translating source code 105 into executable code 165 (e.g., into a STAB). Software source code can typically be written by a developer in a high-level language such as C, C++, Fortran, or other, and stored on a computer readable medium (e.g., storage device(s) 320 or computer readable storage medium 325b). The compiler 110 can compile the source code according to a set of components (e.g., optimizations, etc.), which can be directed, according to embodiments described above, by the compiler driver 140 to result in an application binary having optimized functions 135, corresponding de-optimized functions 137, a linking loader 145, a triage module 147, etc.

Alternate embodiments of a computational environment 300 may have numerous variations from that described above. For example, customized hardware might also be used and/or particular elements might be implemented in hardware, software (including portable software, such as applets), or both. Further, connection to other computing devices such as network input/output devices may be employed. Software of the computational environment 300 may include code 350 for implementing embodiments of the present invention as described herein.

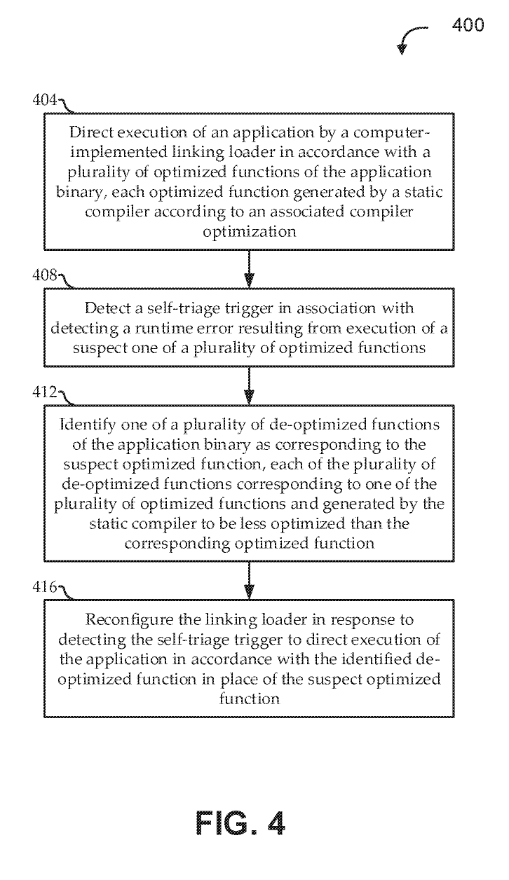

It will be appreciated that various systems, including the systems described above in FIGS. 1-3, can be used to implement embodiments of self-triaging application binaries, and execution and/or compilation thereof. Some embodiments are further described according to the methods of FIG. 4. Where the methods are described in the context of specific system components, those descriptions are intended only for the sake of clarity and should not be construed as limiting the scope of any embodiments.

FIG. 4 shows a flow diagram an illustrative method 400 for self-triaging an application binary, according to various embodiments. Some embodiments of the method 400 begins at stage 404 by directing execution of an application by a computer-implemented linking loader in accordance with multiple optimized functions of the application binary, each optimized function generated by a static compiler according to an associated compiler optimization. At stage 408, embodiments can detect a self-triage trigger in association with detecting a runtime error resulting from execution of a suspect one of a plurality of optimized functions. At stage 412, embodiments can identify one of multiple de-optimized functions of the application binary as corresponding to the suspect optimized function. Each of the plurality of de-optimized functions corresponds to one of the plurality of optimized functions and is generated by the static compiler to be less optimized than the corresponding optimized function (e.g., completely un-optimized, less aggressively optimized, etc.). As described herein, the identification in stage 412 can involve a number of complicated sub-processes (e.g., examining core dumps and/or log files) and/or strategies e.g., iterative approaches, etc.). At stage 416, embodiments can reconfigure the linking loader in response to detecting the self-triage trigger to direct execution of the application in accordance with the identified de-optimized function in place of the suspect optimized function. In some cases, the method 400 can replace one suspect function with one identifies de-optimized function (e.g., as a most devolved case of the method 400). In other cases, the method 400 can be used to replace multiple suspect functions with multiple identified de-optimized functions.

The methods disclosed herein comprise one or more actions for achieving the described method. The method and/or actions may be interchanged with one another without departing from the scope of the claims. In other words, unless a specific order of actions is specified, the order and/or use of specific actions may be modified without departing from the scope of the claims.

Functions of components and steps methods or algorithms described herein may be embodied directly in hardware, in a software module executed by a processor, or in a combination of the two. For example, various illustrative logical blocks, modules, and circuits described may be implemented or performed with a general purpose processor, a digital signal processor (DSP), an ASIC, a field programmable gate array signal (FPGA), or other programmable logic device (PLD), discrete gate, or transistor logic, discrete hardware components, or any combination thereof designed to perform the functions described herein. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. A software module may reside in any form of tangible storage medium. Some examples of storage media that may be used include random access memory (RAM), read only memory (ROM), flash memory, EPROM memory, EEPROM memory, registers, a hard disk, a removable disk, a CD-ROM and so forth. A storage medium may be coupled to a processor such that the processor can read information from, and write information to, the storage medium. In the alternative, the storage medium may be integral to the processor. A software module may be a single instruction, or many instructions, and may be distributed over several different code segments, among different programs, and across multiple storage media. Thus, a computer program product may perform operations presented herein. For example, such a computer program product may be a computer readable tangible medium having instructions tangibly stored (and/or encoded) thereon, the instructions being executable by one or more processors to perform the operations described herein. The computer program product may include packaging material.

Other examples and implementations are within the scope and spirit of the disclosure and appended claims. For example, features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C). Further, the term “exemplary” does not mean that the described example is preferred or better than other examples.

Various changes, substitutions, and alterations to the techniques described herein can be made without departing from the technology of the teachings as defined by the appended claims. Moreover, the scope of the disclosure and claims is not limited to the particular aspects of the process, machine, manufacture, composition of matter, means, methods, and actions described above. Processes, machines, manufacture, compositions of matter, means, methods, or actions, presently existing or later to be developed, that perform substantially the same function or achieve substantially the same result as the corresponding aspects described herein may be utilized. Accordingly, the appended claims include within their scope such processes, machines, manufacture, compositions of matter, means, methods, or actions.

What is claimed is:

1. A computer-implemented compiler system comprising:
a source code store to receive and store source code for an application;
a function parser having:
a source code input coupled with the source code store; and
an unoptimized function-set output comprising a plurality of unoptimized functions parsed from the source code;
a code optimizer having:
an unoptimized function-set input coupled with the unoptimized function-set output;
an optimized function-set output comprising a plurality of optimized functions, each statically compiled from one of the plurality of unoptimized functions according to an associated compiler optimization; and
a de-optimized function-set output comprising a plurality of de-optimized functions, each corresponding to one of the optimized functions, and each statically compiled without the optimization associated with the corresponding optimized function; and
a compiler driver that is coupled with the code optimizer and generates an application binary to comprise:
the plurality of optimized functions;
the plurality of de-optimized functions;
a linking loader that operates to direct execution of the application in accordance with the plurality of optimized functions; and
a triage module that operates to detect a self-triage trigger in association with detecting a runtime error resulting from execution of a suspect one of the plurality of optimized functions, identify one of the plurality of de-optimized functions as corresponding to the suspect optimized function, and reconfigure the linking loader in response to the self-triage trigger to direct execution of the application in accordance with the identified de-optimized function in place of the suspect optimized function.

2. The system of claim 1, wherein at least one of the de-optimized functions is statically compiled without any compiler optimization,

3. The system of claim 1, wherein at least one of the de-optimized functions is statically compiled according to a compiler optimization that is different from the compiler optimization associated with the corresponding optimized function, such that the de-optimized function is less optimized than the corresponding optimized function and more optimized than the corresponding unoptimized function.

4. The system of claim 1, wherein the de-optimized function-set output comprises:
a first de-optimized function-set output comprising a first plurality of de-optimized functions; and
a second de-optimized function-set output comprising a second plurality of de-optimized functions,
wherein at least one of the first plurality of de-optimized functions and one of the second plurality of de-optimized functions correspond to a same one of the optimized functions, the same corresponding optimized function being statically compiled according to a first compiler optimization level, the at least one of the first plurality of de-optimized functions being statically compiled according to a second compiler optimization level that is less optimized than the first compiler optimization level, and the at least one of the second plurality of de-optimized functions being statically compiled according to a third compiler optimization level that is less optimized than the second compiler optimization level.

5. The system of claim 1, wherein:
a code optimizer further has a triage switch input having a self-triage compile mode and a no-triage compile mode;
a de-optimized function-set output is active only when the triage switch input is in the self-triage compile mode; and
the compiler driver generates the application binary to comprise the triage module only when the triage switch input is in the self-triage compile mode.

6. The system of claim 1, wherein the triage module further operates to:
log which of the plurality of optimized functions are executed during execution of the application prior to detecting the runtime error, and identify the suspect optimized function as a last-executed one of the optimized functions according to the log.

7. The system of claim 6, wherein the triage module further operates to:
identify a plurality of suspect optimized functions to correspond to the plurality of optimized functions executed during execution of the application prior to detecting the runtime error according to the log;
identify a plurality of replacement functions as comprising one of the plurality of de-optimized functions corresponding to each of the plurality of suspect optimized function; and
reconfigure the linking loader in response to the self-triage trigger to direct execution of the application in accordance with the identified set of replacement functions in place of the corresponding set of suspect optimized functions.

8. The system of claim 1, wherein the triage module further operates to:
detect a core dump in association with the runtime error, the core dump identifying a set of executed functions;
identify a set of suspect optimized functions to correspond to the set of executed functions identified by the core dump;
identify a set of replacement functions comprising one of the plurality of de-optimized functions corresponding to each of the identified set of suspect optimized function; and
reconfigure, in response to the self-triage trigger, the linking loader to direct execution of the application in accordance with the identified set of replacement functions in place of the corresponding set of suspect optimized functions.

9. The system of claim 1, wherein the triage module further operates to detect the self-triage trigger in response to a user-generated triage command issued subsequent to detecting the runtime error.

10. The system of claim 1, wherein the triage module further operates to detect the self-triage trigger automatically in response to detecting the runtime error.

11. The system of claim 1, further comprising:
an executable code store to receive and store the application binary generated from the compiler driver.

17. A self-triaging application binary comprising:
a plurality of optimized functions, each generated by a static compiler according to an associated compiler optimization;
a plurality of de-optimized functions, each de-optimized function corresponding to one of the optimized functions and generated by the static compiler without the compiler optimization associated with the corresponding optimized function;
a linking loader configured by the static compiler to direct execution of an application in accordance with the plurality of optimized functions; and
a triage module generated by the static compiler to detect a self-triage trigger in association with detecting a runtime error resulting from execution of a suspect one of the plurality of optimized functions, identify one of the plurality of de-optimized functions as corresponding to the suspect optimized function, and reconfigure the linking loader in response to the self-triage trigger to direct execution of the application in accordance with the identified de-optimized function in place of the suspect optimized function.

13. The self-triaging application binary of claim 12, further comprising:
a data store configured to have stored thereon a log of which of the plurality of optimized functions were executed during execution of the application prior to detecting the runtime error,
wherein the triage module is generated further to identify the suspect optimized function as a last-executed one of the optimized functions according to the log.

14. The self-triaging application binary of claim 13, wherein the triage module is generated further to:
identify a set of suspect optimized functions to correspond to the plurality of optimized functions executed during execution of the application prior to detecting the runtime error according to the log;
identify a set of replacement functions comprising one of the plurality of de-optimized functions corresponding to each of the set of suspect optimized function; and
reconfigure, in response to the self-triage trigger, the linking loader to direct execution of the application in accordance with the identified set of replacement functions in place of the corresponding set of suspect optimized functions.

15. The self-triaging application binary of claim 12, wherein the triage module is generated further to:
detect a core dump in association with the runtime error, the core dump identifying a set of executed functions;
identify a set of suspect optimized functions to correspond to the set of executed functions identified by the core dump;
identify a set of replacement functions comprising one of the plurality of de-optimized functions corresponding to each of the identified set of suspect optimized function; and
reconfigure the linking loader in response to the self-triage trigger to direct execution of the application in accordance with the identified set of replacement functions in place of the corresponding set of suspect optimized functions.

16. The self triaging application binary of claim 12, wherein at least one of the de-optimized functions is generated by the static compiler without any compiler optimization.

17. The self-triaging application binary of claim 12, wherein at least a first and second of the de-optimized functions corresponds to a same one of the optimized functions, each of the first de-optimized function, the second de-optimized function, and the corresponding optimized function generated by the static compiler according to different compiler optimization levels.

18. The self-triaging application binary of claim 12, wherein the self-triage trigger is detected in response to a user-generated triage command issued subsequent to detecting the runtime error.

19. The self-triaging application binary of claim 12, wherein the self-triage trigger is detected automatically by the triage module in response to detecting the runtime error.

20. A method for self-triaging an application binary, the method comprising:
directing execution of an application by a computer-implemented linking loader in accordance with a plurality of optimized functions of the application binary, each optimized function generated by a static compiler according to an associated compiler optimization;
detecting a self-triage trigger in association with detecting a runtime error resulting from execution of a suspect one of the plurality of optimized functions;
identifying one of a plurality of de-optimized functions of the application binary as corresponding to the suspect optimized function, each of the plurality of de-optimized functions corresponding to one of the plurality of optimized functions and generated by the static compiler to be less optimized than the corresponding optimized function; and
reconfiguring the linking loader in response to detecting the self-triage trigger to direct execution of the application in accordance with the identified de-optimized function in place of the suspect optimized function.
